(19) United States
(12) Patent Application Publication
(10) Pub. No.: US 2019/0012633 A1
(43) Pub. Date: Jan. 10, 2019

(54) DEFAULT VENUE MAPS

(71) Applicant: BROKER GENIUS, INC., Far Rockaway, NY (US)

(72) Inventors: Shmuel Sherman, Valley Stream, NY (US); Jim McGowan, Flemington, NJ (US)

(21) Appl. No.: 16/031,860

(22) Filed: Jul. 10, 2018

Related U.S. Application Data
(60) Provisional application No. 62/530,831, filed on Jul. 10, 2017.
(60) Provisional application No. 62/530,833, filed on Jul. 10, 2017.
(60) Provisional application No. 62/530,834, filed on Jul. 10, 2017.
(60) Provisional application No. 62/530,836, filed on Jul. 10, 2017.

(51) Int. Cl. G06Q 10/08; G06Q 30/02

(52) U.S. Cl. CPC G06Q 10/087; G06Q 30/0206; G06Q 30/0201

(57) ABSTRACT

In one particular implementation, an access credential inventory management system is provided. In a particular configuration, the system includes at least last one database configured to store one or more listings of credential inventory data, wherein the credential inventory data includes at least a data object corresponding to each of a plurality of access credentials, wherein the data object includes a value indicative of the availability of the associated access credential. The system also includes a processor having a memory and configured to receive the data object that includes reference to listing of access credentials, wherein each listing includes reference to at least one access credential and determine the number of access credentials referenced by the listing of the data object. The processor is also configured by code to receive one or more data values corresponding to market data relating to comparable listings, where each comparable listing has at least one feature in common with the listing included in the received data object; and receive one or more data values corresponding to market data relating to presently available listings for the same event as the access credential provides access. In a further implementation, the processor also is configured to further filter the presently available data set based on the historical dataset, and update the price of the listing in response to the filtering.

### CROSS REFERENCE TO RELATED APPLICATIONS

This Application claims priority to U.S. application Ser. No. 62/530,831, filed on Jul. 10, 2017 and herein incorporates by reference the same. This Application claims priority to U.S. application Ser. No. 62/530,833, filed on Jul. 10, 2017 and herein incorporates by reference the same. This Application claims priority to U.S. application Ser. No. 62/530,834, filed on Jul. 10, 2017 and herein incorporates by reference the same. This Application claims priority to U.S. application Ser. No. 62/530,836, filed on Jul. 10, 2017, and herein incorporates by reference the same. Each of the foregoing Applications are incorporated by reference as if presented in their entirety.

### BACKGROUND OF THE INVENTION

In the access credential secondary market (e.g. ticket reselling) the technique of comp-based pricing involves choosing listings that are comparable to each target listing a seller wishes to offer for sale. Comparable listings provide some guidance to pricing a particular access credential for sale where each access credential is essentially a unique product and no exact comparable to another offered product is possible. Comparable based pricing allows the use of market data for similar but non-identical listings to calculate a price for the target listing. As used herein, a listing is a group of seats referenced by one or more access credentials, and sold in a single transaction.

One cumbersome part of initially pricing listings is selecting the comparable listings or “comps” that serve as the basis for determining the price of the underlying access credentials within a listing. Typically, a seller (often referred to as a broker) seeks to pick listings in a similar region of the event venue, with a comparative number of tickets or “split.” For instance, one strategy for pricing a ticket is to select a price comparable. For example, where the ticket to be priced refers to a seat in the sixth-row of a particular section of a venue for a given event, the comparable price can be the prices for seats in the fifth through tenth row in that same section or area, or a lateral sections, and/or a similar section on the opposite side of the relevant venue. This is also true where the split size (i.e., the same number of tickets in the listing) is the same. The split size is the same between the ticket(s) in need of pricing and the comparable tickets. Such information is important, since a limited supply of splits with large numbers of tickets may demand a premium price relative to the value of the individual tickets.

Thus, what is needed in the art are systems, methods and computer products that allow for the automatic updating and generating of comparable prices for tickets. For example, the present systems, methods and computer products improve upon current systems by automating data associated with venue maps to include default values for listings that are likely to match the quality of the comps assigned by an experienced pricing agent.

### SUMMARY OF THE INVENTION

The systems, methods and apparatus described herein are directed to automated comparable listing identification for a given venue. For example, the automated assignment of comparable listings utilizes one or more processors operating in concert to identify related features so as to identify listing having substantially similar marketable features and assigning a price based thereupon.

In one particular implementation, an access credential inventory management system is provided. In a particular configuration, the system includes at least last one database configured to store one or more listings of credential inventory data, wherein the credential inventory data includes at least a data object corresponding to each of a plurality of access credentials, wherein the data object includes a value indicative of the availability of the associated access credential. The system also includes a processor having a memory and configured to receive the data object that includes reference to listing of access credentials, wherein each listing includes reference to at least one access credential and determine the number of access credentials referenced by the listing of the data object. The processor is also configured by code to receive one or more data values corresponding to market data relating to comparable listings, where each comparable listing has at least one feature in common with the listing included in the received data object; and receive one or more data values corresponding to market data relating to presently available listings for the same event as the access credential provides access. In a further implementation, the processor also is configured to further filter the presently available data set based on the historical dataset, and update the price of the listing in response to the filtering.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram illustrating particular elements according to one embodiment of the present invention.

FIG. 2A is a flow diagram illustrating a particular implementation according to one embodiment of the present invention.

FIG. 2B is a flow diagram illustrating an alternative embodiment according to one embodiment of the present invention.

FIG. 3 presents a collection of modules detailing the operative functions of the access credential management system according to one configuration of the present invention.

FIG. 4 presents a graphical user interface details one or more operative functions of the access credential management system according to one configuration of the present invention.

### DETAILED DESCRIPTION OF CERTAIN EMBODIMENTS OF THE INVENTION

This application is herein incorporates by reference: U.S. patent application No. [TBD] and titled “System and Apparatus for the Display and Selection of Listings and Splits” filed concurrently herewith and having attorney docket number 10153/006064-US1; U.S. patent application No. [TBD] and titled “Automated Comparable-Based Pricing Using Non-Zero-Difference Comparables” filed concurrently herewith and having attorney docket number 10153/006065-US1; and U.S. patent application No. [TBD] and titled “Various Methods for Displaying Venue Information on a Venue Map” filed concurrently herewith and having attorney docket number 10153/006066-US1. Each of the foregoing Applications are incorporated by reference as if presented in their entirety.

By way of overview and introduction, various embodiments of the systems and methods described herein are directed a computer system configured to implement comparable listing mechanisms to identify item listing having market similarities to a given sale item.

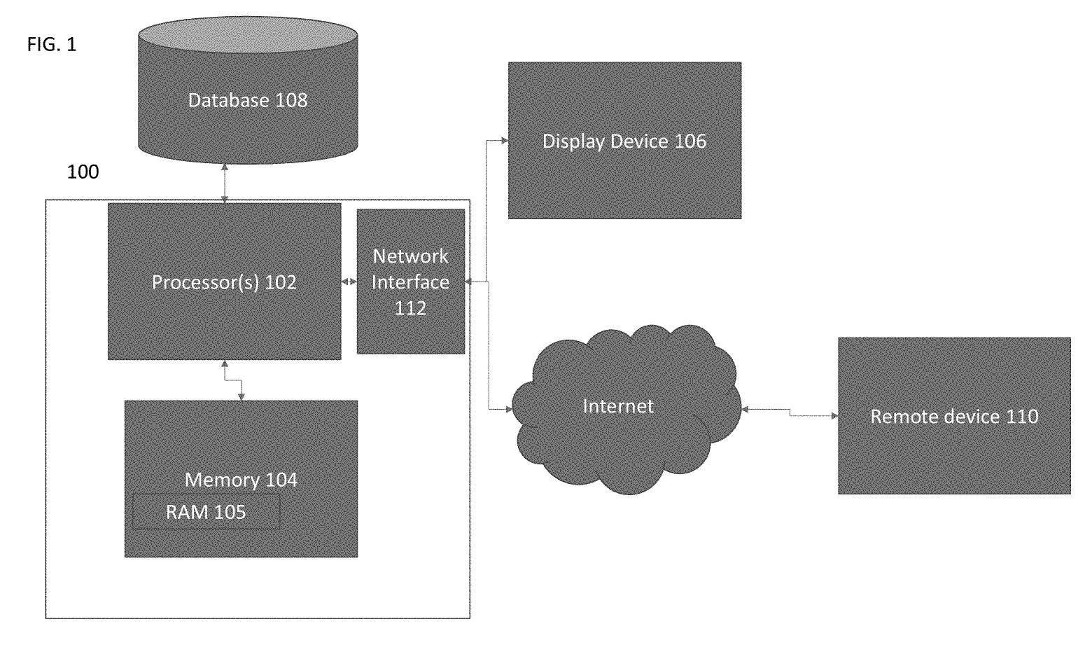

Turning to FIG. 1, a computer system 100 is provided to access, evaluate and transform data. In one or more configurations, the computer system 100 is composed of one (1) or more processors 102 configured to execute code residing therein. For instance, in one implementation, the computer system is a standard computing device such as, but not limited to, commercially available computing device. For example, the processor 102 may be a collection of computers, servers, processors, cloud-based computing elements, micro-computing elements, computer-on-chip(s), home entertainment consoles, media players, set-top boxes, prototyping devices or “hobby” computing elements.

Furthermore, the processor 102 can comprise a single processor, multiple discrete processors, a multi-core processor, or other type of processor(s) known to those of skill in the art, depending on the particular embodiment. In a particular example, the processor 102 executes software code on the hardware of a custom or commercially available cellphone, smartphone, notebook, workstation or desktop computer configured to receive data either directly from one or more memories or data storage devices, or indirectly through a communication linkage to one or more memories or data storage devices, such as database 108.

The processor 102 is configured to execute a commercially available or custom operating system, e.g., MICROSOFT WINDOWS, APPLE OSX, UNIX or Linux based operating system in order to carry out instructions or code.

In one or more implementations, the color processor 102 is further configured to access various peripheral devices and network interfaces. For instance, the processor 102 is configured to communicate over the internet with one or more remote servers, computers, peripherals or other hardware using standard or custom communication protocols and settings (e.g., TCP/IP, etc.).

The processor 102 may include one or more memory storage devices (memories). The memory is a persistent or non-persistent storage device (such as an IC memory element) that is operative to store the operating system in addition to one or more software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of the processor 104 provides for the storage of application program and data files. One or more memories provide program code that the processor 104 reads and executes upon receipt of a start, or initiation signal.

The computer memories may also comprise secondary computer memory, such as magnetic or optical disk drives or flash memory, that provide long term storage of data in a manner similar to a persistent memory device. In one or more embodiments, the memory of the processor 102 provides for storage of an application program and data files when needed.

In one implementation, each element provided in FIG. 1 is configured to communicate with one another through one or more direct connections, such as though a common bus. Alternatively, each element is configured to communicate with the others through network connections or interfaces, such as a local area network LAN or data cable connection. In an alternative implementation, the display device 106, processor 104, and database 108 are each connected to a network, such as the internet, and are configured to communicate and exchange data using commonly known and understood communication protocols.

In a particular implementation, the processor 102 is a computer, workstation, thin client or portable computing device such as an Apple iPad/iPhone® or Android® device or other commercially available mobile electronic device configured to receive and output data to or from database 108 and or a display device 106, or remote device 110.

Here, the processor 102 communicates with a display device 106 for displaying data as well as receiving input from hardware associated with the display device (such as a remote computing device) that permits a user to access information, and to send commands and/or instructions to the processor 102 and/or the database 108. In one or more implementations, the display device 106 is a screen, monitor, display, LED, LCD or OLED panel, augmented or virtual reality interface or an electronic ink-based display device.

Those possessing an ordinary level of skill in the requisite art will appreciate that additional features, such as power supplies, power sources, power management circuitry, control interfaces, relays, interfaces, and/or other elements used to supply power and interconnect electronic components and control activations are appreciated and understood to be incorporated.

As shown, memory 104 and persistent storage 108 are examples of computer-readable tangible storage devices. A storage device is any piece of hardware that is capable of storing information, such as, data, program code in functional form, and/or other suitable information on a temporary basis and/or permanent basis. In one or more embodiments, memory 104 includes random access memory (RAM) 105. RAM 105 may be used to store data such as the venue data in accordance with the present invention. In general, memory 104 can include any suitable volatile or non-volatile computer-readable storage device. Software and data are stored in persistent storage 108 for access and/or execution by processors 102 via one or more memories of memory 104. With respect to remote computing device 110, for example, software and data are stored locally on the remote computing device 110.

In a particular embodiment, persistent storage 108 includes a magnetic hard disk drive. Alternatively, or in addition to a magnetic hard disk drive, persistent storage 108 can include a solid state hard drive, a semiconductor storage device, read-only memory (ROM), erasable programmable read-only memory (EPROM), flash memory, or any other computer-readable storage devices capable of storing program instructions or digital information.

The database 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art.

The media used by persistent storage 108 may also be removable. For example, a removable hard drive may be used for persistent storage 108. Other examples include optical and magnetic disks, thumb drives, and smart cards that are inserted into a drive for transfer onto another computer-readable storage medium that is also part of persistent storage 108.

Communications or network interface unit 112, in the forgoing examples, mediate communications with other sub-systems or devices. In an embodiment, communications unit 112 may provide appropriate interfaces to the Internet or other suitable data communications network to connect to one or more servers, resources, API hosts, or computers. In these examples, communications unit 112 may include one or more network interface cards. Communications unit 112 may provide communications through the use of either or both physical and wireless communications links.

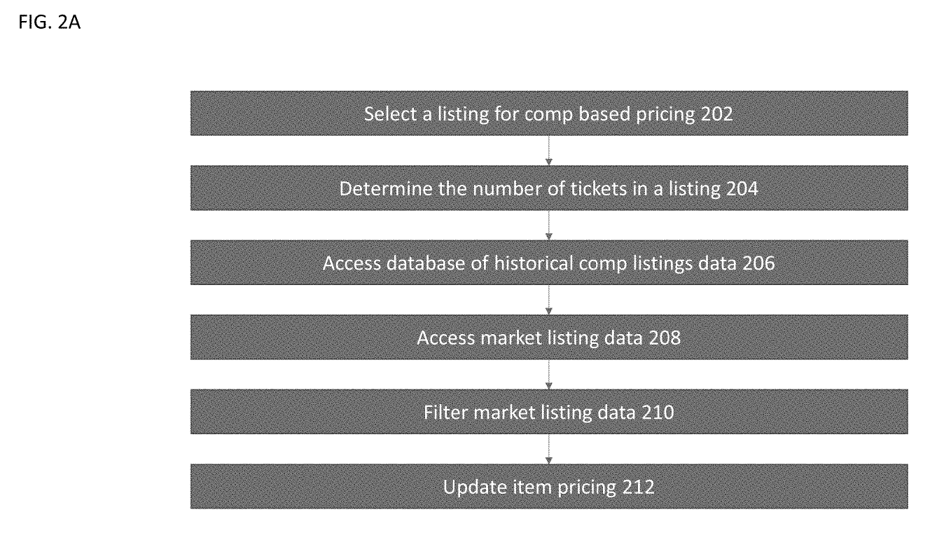

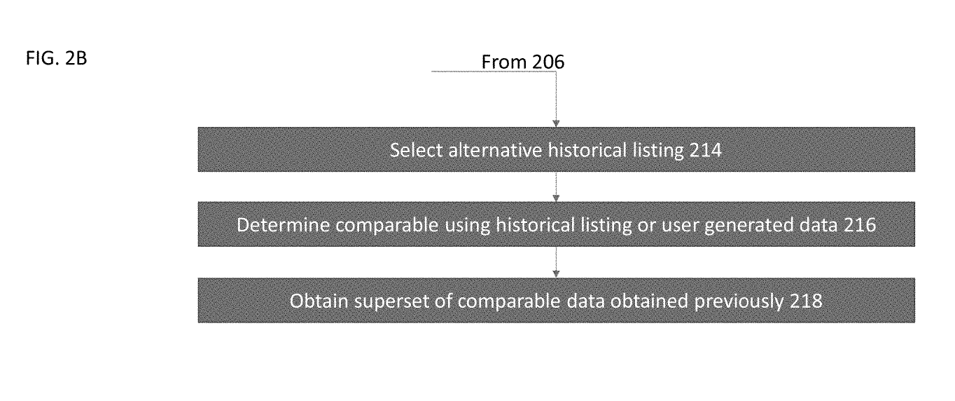

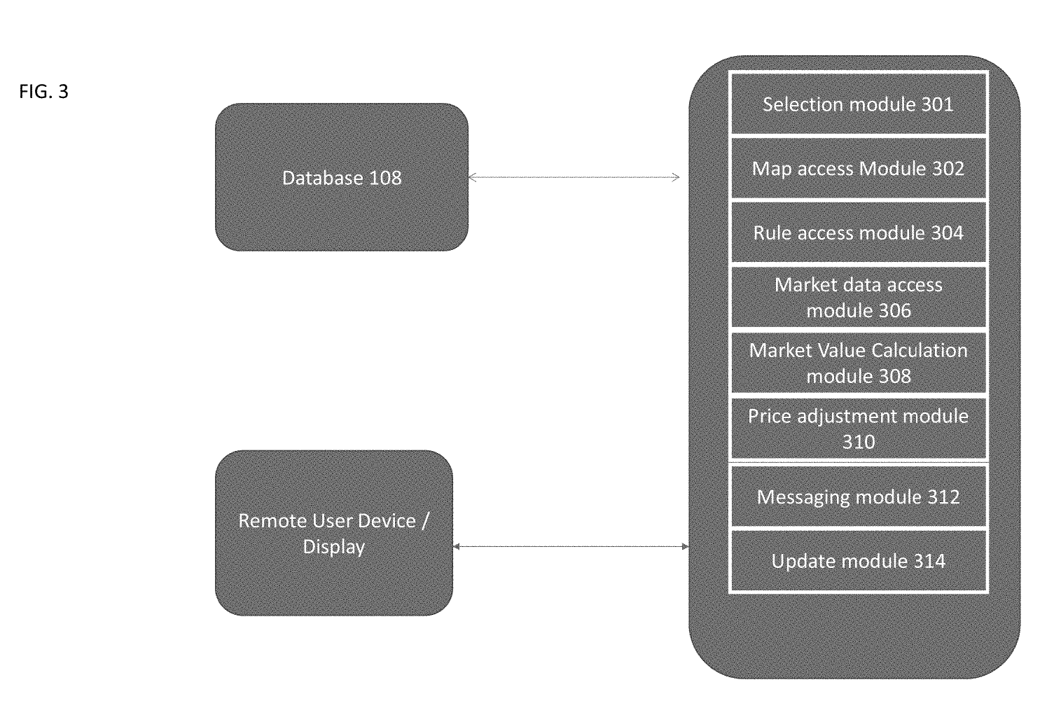

Returning to the systems and methods described herein, the computer system is configured by one or more software modules (such as those provided in FIG. 3) executed as code by the processor(s) 102 to implement the steps provided in FIGS. 2A-2B.

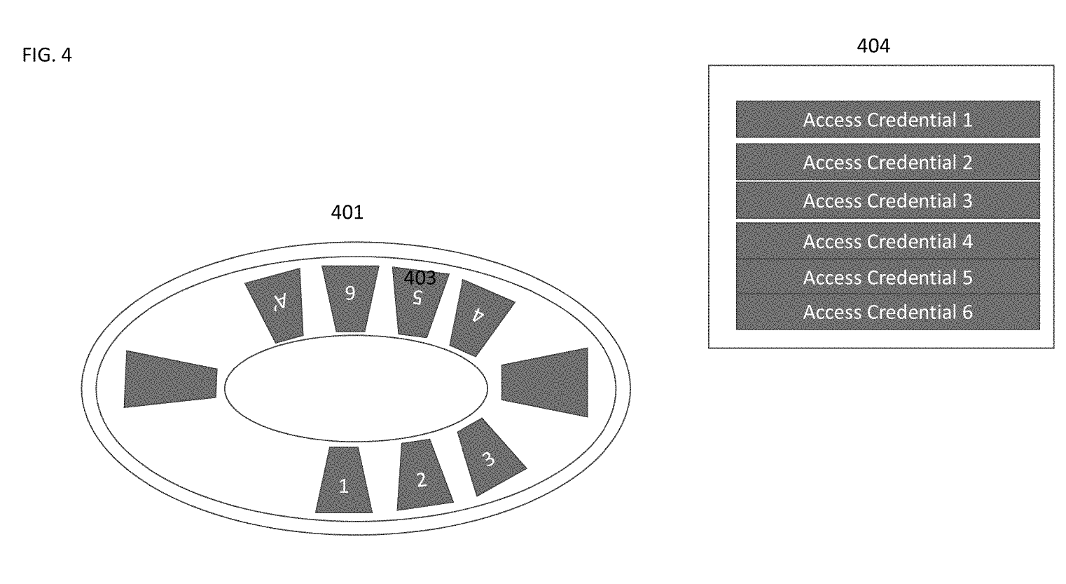

For example, a suitably configured processor 102 selects a listing for comp-based pricing as in step 202. In a particular configuration, the selection module 302 configures the processor 102 to select an access credential from a database of access credentials. By way of non-limiting example, the processor 102 configured by the selection module 302 is configured to receive a selection from a user, such as a user of remote device 110. In a further implementation, upon receipt of one or more user selections; data representing selection of access credentials to a system capable of such pricing, data received from an Application Programming Interface (API) or a similar data source or interface, the processor 102 is configured to evaluate the data for pricing. In yet a further implementation, a user of the remote device 110 is able to exchange data with the processor 102 to effectuate the selection of a listing, such as one of listings 404 of the GUI of FIG. 4. In one implementation, such listings are only accessible from a database 108 that is accessible only by processor 102 and the selections made by the user are selections of references passed to the GUI by the processor 102.

For example, in one implementation, a user of a display device 106 or remote computing device 110 makes a selection of one or more access credentials for pricing on a local computing device. The local computing device (such as remote computing device 110) is configured to transmit to processor 102 references to the selections. Here, such references can include one or more file or database look up locators, indexes or pointers. Upon receipt of the reference information, the processor 102 is configured with a database query module operable as a submodule of the selection module 302, that functions to query the database 108 and updates the user interface (404) of the remote device 110 so as to display the requested data.

Returning to the flow diagram of FIG. 2A, a suitably configured processor 102 is configured to determine the number of tickets within the listing as shown in step 204. For example, where the listing is a text or data object, the processor 102 is configured by a parsing module 304 to parse the data to extract the number of tickets present in the listing. For example, the parsing module 304 configures to the processor 102 to use one of more natural language processing techniques to parse information or metadata associated with a listing to determine the “split” or other information relevant to the number of tickets included in the listing.

Upon determining the number of tickets in a listing, a suitably configured processor 102 is configured to access a database of historical comp-based listings as shown in step 206. In one implementation, the processor 102 is configured by a historical comp module 206 to access prior sales data for a given venue, event or combination thereof. In one or more implementations, the historical comp module 206 is configured to access database 108 and extract one or more prior purchase prices for one or more access credentials that have one or more features in common with the selected listings, or portions thereof. In one arrangement common features include similar type or class of event, amount of total tickets available in a venue, price of tickets, location, or any combination thereof.

In an particular arrangement, the historical database is a database remote to the processor 102. For example, the historical database is accessible via one or more network connection, APIs, web portals, or custom software solutions. Here, the historical database contains data used by the suitably configured processor 102 to determine seats used in comp-based pricing in past events in the same venue.

Alternatively, where historical data is unavailable, a list of comparable seats, rows and/or sections may be determined for the stadium by a user. For example, a user of a remote device 110 selects from a database of historical data information representing an approximate comparable pricing to the present item. By way of non-limiting example, the user of the remote computing device selects from the venue map 401, one or more comparable listings (A′) for pricing against the selection.

As shown with respect step 208, a suitably configured processor 102 is configured to access or obtain available listings within the market. For instance, a processor 102 is configured by a real-time query module 308 to execute one or more database queries on real-time ticket exchanges, data pools or other data sources to obtain the current market listing data. In one or more implementations, the real-time query module is configured to simultaneous query multiple databases and harmonize the return results. For example, where there is a fragmented secondary marketplace, multiple databases may contain relevant data. As such, the real-time query module is configured to aggregate or combine responses to multiple database queries.

As shown in FIG. 2A, the market data is filtered by the processor 102 using one or more filtering criteria. As shown with respect to step 210, a processor 102 configured by a filtering module 310 to identify comparable listings. In one non-limiting implementation, the suitably configured processor 102 is configured by the filtering module 310 to identify listings that are both (a) for seats matching those from the historical record, and (b) equal or similar to the number of tickets within the selected listing.

Once the comparable price(s) for tickets has been identified, as in step 210, the processor 102 is configured by a price adjustment module 312 to adjust the price data associated with a particular ticket as shown in step 212. For example, the processor 102 is configured to change a value in the database 108 associated with the relevant access credential.

It will be appreciated by those possessing an ordinary level of skill in the relevant art that as tickets in the venue sell, fewer comparable listings are available. Therefore, a suitably configured processor 102 may be configured to increase the comparable region by adjusting the factors for comparison. For example, processor 102 is further configured by the filtering module to alter the filtering criteria in response to the total number of available listings that may be compared against the selected listing. For example, the processor 102 is configured to adjust the filtering criteria such that listings with more tickets are returned in the results. In another implementation, a suitably configured processor 102 includes listings having a greater number of seats that the current inventory.

Where the comparable listings are increased to include listings having a greater number of seats, a different historical record or user-generated comp list is evaluated by a suitably configured processor.

As shown in FIG. 2B, the suitably configured processor 102 further evaluates the data by obtaining the original comparable listing data obtained in step 206. Alternatively, the suitably configured processor 102 is configured to access alternative comparable listing data created by a user and accessible from a storage location as in step 212.

For each seat in the list, the suitably configured processor 102 determines the comparables for that seat using either historical data or the alternate comps created by a user, as in step 214.

Finally, the suitably configured processor 102 obtains the superset of all comparables for all seats in the original list obtained in step 212 or 214, as shown in step 216.

The selection process illustrated in FIG. 2B process is implemented to widen the available comparable listings. By way of non-limiting example, the five sections, each section is comparable to one greater and one lesser section. For instance, for sections 1, 2, 3, 4, 5, and 6 of FIG. 4, section 3 listings are originally compared to listings in sections 2 and 4. Section 2 is compared to sections 1 and 3, and section 4 is compared to sections 3 and 5.

After application of the process described herein, section 3 is compared to sections 1 and 5 as well.

In a further implementation, the suitably configured processor 102 repeats the application of the comparable identification process. In yet a further implementation, the repeated application of this process is configured to capture include all seats within the venue.

Those possessing an ordinary level of skill in the requisite art will appreciate that the where the present invention is a system, a method, and/or a computer program product, the he computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Haskell, R, Clojure, javascript, C#, Swift, Lua, Pearl, Python, Ruby, or the like, and conventional procedural programming languages, such as the “C” programming language, object-oriented programming languages, functional programming languages or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The block diagrams in the illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments may be utilized in many different types of data processing environments. In order to provide a context for the description of the specific elements and functionality of the illustrative embodiments, are provided hereafter as example environments in which aspects of the illustrative embodiments may be implemented. It should be appreciated that are only examples and are not intended to assert or imply any limitation with regard to the environments in which aspects or embodiments of the present invention may be implemented. Many modifications to the depicted environments may be made without departing from the spirit and scope of the present invention.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying FIGs. do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the claims that follow, the respective features recited in those points, and by equivalents of such features.

What is claimed:

1. An access credential inventory management system comprising:
at least one database configured to store credential inventory data, wherein the credential inventory data includes at least a data object corresponding to a listing of access credentials, wherein each listing refers to one or more access credentials associated with the listing, and a data object includes a value indicative of the availability of the associated access credential; and
a processor having a memory and configured to:
receive a data object that includes reference to the listing of access credentials, wherein each listing includes reference to at least one access credential,
determine the number of access credentials referenced by the listing of the data object;
receive one or more data values corresponding to market data relating to comparable listings, where each comparable listing has at least one feature in common with the listing include in the received data object;
receive one or more data values corresponding to market data relating to presently available listings for the same event as the access credential provides access;
filter the presently available data set based on the comparable listing dataset, update the price of the listing in response to the filtering.

2. The system of claim 1, wherein the comparable listings are a data set of previously sold listings.

3. The system of claim 2, where the processor is configured to filter the present dataset for entries that (a) match entries from the previously sold listing data set, and (b) are equal or similar to the number of tickets within the selected listing.

4. The system of claim 3, where the processor is configured to:
generate a secondary comparable set that is different that the first comparable set;
price each access credential reference included in the listing, based on a comparison to either the secondary comparable set or the comparable dataset.

5. The system of claim 4, wherein the secondary comparable set is a user defined comparable set received from one or more remote storage locations.

6. An access credential inventory management method comprising:
Receiving, by a processor having a memory and configured by code, a data object that includes reference to the listing of access credentials, wherein each listing includes reference to at least one access credential,
determining the number of access credentials referenced by the listing of the data object;
receiving one or more data values corresponding to market data relating to comparable listings, where each comparable listing has at least one feature in common with the listing include in the received data object;
receiving one or more data values corresponding to market data relating to presently available listings for the same event as the access credential provides access;
filtering the presently available data set based on the comparable listing dataset, and
updating the price of the listing in response to the filtering.

7. The method of claim 6, wherein the comparable listings are a data set of previously sold listings.

8. The method of claim 7, where the processor is configured to filter the present dataset for entries that (a) match entries from the previously sold listing data set, and (b) are equal or similar to the number of tickets within the selected listing.

9. The method of claim 8, where the processor is configured to:
generate a secondary comparable set that is different that the first comparable set;
price each access credential reference included in the listing, based on a comparison to either the secondary comparable set or the comparable dataset.

10. The system of claim 9, wherein the secondary comparable set is a user defined comparable set received from one or more remote storage locations.
